(19) United States
(12) Patent Application Publication
(10) Pub. No.: US 2025/0201937 A1
(43) Pub. Date: Jun. 19, 2025

(54) SOLID-STATE BATTERY

(71) Applicant: TOYOTA JIDOSHA KABUSHIKI KAISHA, Aichi-ken (JP)

(72) Inventor: Naotaka TANIMOTO, Nisshin-shi (JP)

(21) Appl. No.: 18/979,604

(22) Filed: Dec. 13, 2024

(30) Foreign Application Priority Data
Dec. 15, 2023 (JP) 2023-212548

(51) Int. Cl. H01M 10/42; H01M 10/058

(52) U.S. Cl. CPC H01M 10/4235; H01M 10/058

(57) ABSTRACT

A solid-state battery includes: a positive electrode layer that contains a positive electrode active material and a solid electrolyte; a negative electrode layer that contains a negative electrode active material and a solid electrolyte; and a solid electrolyte layer that is arranged between the positive electrode layer and the negative electrode layer, wherein a particle diameter of a solid electrolyte that is included in the solid electrolyte layer is smaller than a particle diameter of the solid electrolyte that is included in the positive electrode layer and smaller than a particle diameter of the solid electrolyte that is included in the negative electrode layer.

### CROSS-REFERENCE TO RELATED APPLICATION

This application is based on and claims priority under 35 USC 119 from Japanese Patent Application No. 2023-212548 filed on Dec. 15, 2023, the disclosure of which is incorporated by reference herein.

### BACKGROUND

### Technical Field

The present disclosure relates to a solid-state battery.

### Related Art

In recent years, the importance of secondary batteries has increased, and development of solid-state batteries using solid electrolytes in addition to secondary batteries equipped with electrolytic solutions has advanced. An all-solid-state battery, which is an example of a solid-state battery, is a battery having a solid electrolyte layer in place of an electrolytic solution, and since a combustible organic solvent is not used, the safety device can be simplified, and the manufacturing cost and productivity are excellent. Patent Document 1 discloses including an active material layer in which a solid electrolyte and an active material are continuously vertically arranged, the solid electrolyte having a particle diameter that is less than the film thickness of an electrode, and specifically, the particle diameter of the solid electrolyte being less than 50 μm. According to Japanese Patent Application (JP-A) No. 2015-018777, the mobility of Li ions in an electrode is said to be improved.

Furthermore, Japanese Patent Application (JP-A) No. 2012-243644 discloses that in an electrode including an active material layer containing active material particles and solid electrolyte particles, the average particle diameter of the solid electrolyte particles is smaller than the average particle diameter of the active material particles. According to Patent Document 2, contact between active material particles and solid electrolyte particles in an active material layer can be improved, and Li-ion conductivity in the active material layer is said to be improved compared to the prior art.

Furthermore, Japanese Patent Application (JP-A) No. 2021-163622 discloses an all-solid-state battery including a solid electrolyte layer, and a heat-resistant resin layer having ionic conductivity, in order to prevent short circuiting due to generation of dendrites. According to Patent Document 3, it is said that the heat-resistant resin layer functions as a short-circuit prevention layer.

### SUMMARY

In solid-state batteries in which a positive electrode, a solid electrolyte layer, and a negative electrode are layered in this order, it is sometimes difficult to exhibit stable battery performance due to foreign matter present in the positive electrode and/or the negative electrode moving to the solid electrolyte layer.

In view of the foregoing circumstances, it is an object of the present disclosure to provide a solid-state battery in which even if foreign matter is present in the positive electrode and/or the negative electrode, movement of the foreign matter to the solid electrolyte layer is suppressed, whereby stable battery performance can be exhibited.

### Means for Solving the Problem

The present disclosure, which has achieved the above-described object, encompasses the following.

A first aspect of the preset disclosure provides a solid-state battery includes: a positive electrode layer that contains a positive electrode active material and a solid electrolyte; a negative electrode layer that contains a negative electrode active material and a solid electrolyte; and a solid electrolyte layer that is arranged between the positive electrode layer and the negative electrode layer, wherein a particle diameter of a solid electrolyte that is included in the solid electrolyte layer is smaller than a particle diameter of the solid electrolyte that is included in the positive electrode layer and smaller than a particle diameter of the solid electrolyte that is included in the negative electrode layer.

A second aspect of the present disclosure provides the solid-state battery according to the first aspect of the present disclosure, wherein a relative value of the particle diameter of the solid electrolyte that is included in the solid electrolyte layer is less than or equal to 0.5 in a case in which a value of a smaller particle diameter among the solid electrolyte that is included in the positive electrode layer and the solid electrolyte that is included in the negative electrode layer is set to 1.

A third aspect of the present disclosure provides the solid-state battery according to the first aspect of the present disclosure, wherein a relative value of the particle diameter of the solid electrolyte that is included in the solid electrolyte layer is less than or equal to 0.2 in a case in which a value of a smaller particle diameter among the solid electrolyte that is included in the positive electrode layer and the solid electrolyte that is included in the negative electrode layer is set to 1.

In the solid-state battery according to the present disclosure, foreign matter present in the positive electrode layer and/or the negative electrode layer can be suppressed from moving to the solid electrolyte layer, whereby stable battery performance can be exhibited.

### BRIEF DESCRIPTION OF THE DRAWINGS

Exemplary embodiments will be described in detail based on the following figures, wherein:

FIG. 1 is a schematic diagram illustrating a structure of the main parts of a solid-state battery shown as an embodiment of the present disclosure; and

FIG. 2 is a schematic diagram illustrating a structure of a foreign matter short-circuit test carried out in the present Examples.

### DETAILED DESCRIPTION

A solid-state battery according to the present disclosure includes a positive electrode layer that contains a positive electrode active material and a solid electrolyte, a negative electrode layer that contains a negative electrode active material and a solid electrolyte, and a solid electrolyte layer that is arranged between the positive electrode layer and the negative electrode layer, wherein a particle diameter of a solid electrolyte contained in the solid electrolyte layer is smaller than a particle diameter of the solid electrolyte contained in the positive electrode layer and smaller than a particle diameter of the solid electrolyte contained in the negative electrode layer.

In the solid-state battery according to the present disclosure, since the particle diameter of the solid electrolyte contained in the solid electrolyte layer is smaller than the particle diameter of the solid electrolyte contained in the positive electrode layer and smaller than the particle diameter of the solid electrolyte contained in the negative electrode layer, in a case in which foreign matter is present in the positive electrode layer or the negative electrode layer, the foreign matter can be prevented from moving to the solid electrolyte layer. As a result, in the case in which the foreign matter is a substance having conductivity such as a piece of metal, a short circuit between the positive electrode layer and the negative electrode layer can be prevented. Furthermore, in the case in which the foreign matter is a substance not having conductivity, inhibition of ion conductivity in the solid electrolyte layer can be prevented. As a result, in the solid-state battery according to the present disclosure, movement of foreign matter to the solid electrolyte layer is suppressed, whereby stable battery performance can be exhibited.

### Solid Electrolyte

In the present disclosure, the particle diameter of the solid electrolyte contained in the solid electrolyte layer, the positive electrode layer, and the negative electrode layer can be compared in size with the particle diameter defined by the average particle diameter D50. It should be noted that the solid electrolyte contained in the solid electrolyte layer, the positive electrode layer, and the negative electrode layer may be the same component or may be different components. D50, which indicates the average particle diameter, is also referred to as the median diameter, and indicates the particle diameter at which the cumulative frequency from the side having the smaller particle diameter reaches 50% in the volume-based particle diameter distribution. D50 for particles such as solid electrolytes is a value that is measured by a laser diffraction method and can be measured using a laser diffraction scattering intensity distribution measuring apparatus.

In the present disclosure, the particle diameter of the solid electrolyte contained in the solid electrolyte layer may be significantly smaller than the particle diameter of the solid electrolyte contained in the positive electrode layer and the particle diameter of the solid electrolyte contained in the negative electrode layer. Here, significantly means that there is a statistically significant difference. The statistically significant difference can be determined according to a method in which data obtained by measuring the particle diameter of the solid electrolyte contained in the solid electrolyte layer plural times and data obtained by measuring the particle diameter of the solid electrolyte contained in the positive electrode layer and the particle diameter of the solid electrolyte contained in the negative electrode layer plural times are compared by, for example, a t-test. If the particle diameter of the solid electrolyte contained in the solid electrolyte layer is significantly smaller than the particle diameter of the solid electrolyte contained in the positive electrode layer and the particle diameter of the solid electrolyte contained in the negative electrode layer, it becomes less likely that foreign matter that is contained in the positive electrode layer or the negative electrode layer will move to the solid electrolyte layer as compared to the case in which a solid electrolyte having the same particle diameter is used for the solid electrolyte layer, the positive electrode layer, and the negative electrode layer.

In particular, it is preferable that a relative value of the particle diameter of the solid electrolyte contained in the solid electrolyte layer is less than or equal to 0.9, less than or equal to 0.8, less than or equal to 0.7, less than or equal to 0.6, less than or equal to 0.5, less than or equal to 0.4, less than or equal to 0.3, less than or equal to 0.2, or less than or equal to 0.1 when a value of the smaller particle diameter among the particle diameter of the solid electrolyte contained in the positive electrode layer and the particle diameter of the solid electrolyte contained in the negative electrode layer is set to 1. In particular, a relative value of the particle diameter of the solid electrolyte contained in the solid electrolyte layer is more preferably less than or equal to 0.5, less than or equal to 0.4, less than or equal to 0.3, less than or equal to 0.2, or less than or equal to 0.1 when a value of the smaller particle diameter among the particle diameter of the solid electrolyte contained in the positive electrode layer and the particle diameter of the solid electrolyte contained in the negative electrode layer is set to 1. Furthermore, a relative value of the particle diameter of the solid electrolyte contained in the solid electrolyte layer is preferably less than or equal to 0.2, and most preferably less than or equal to 0.1, when a value of the smaller particle diameter among the particle diameter of the solid electrolyte contained in the positive electrode layer and the particle diameter of the solid electrolyte contained in the negative electrode layer is set to 1. It should be noted that in a case in which the solid electrolyte contained in the positive electrode layer and the solid electrolyte contained in the negative electrode layer have the same particle diameter, this particle diameter is set to 1 and the particle diameter of the solid electrolyte contained in the solid electrolyte layer is set to the above-described range.

In a case in which the particle diameter of the solid electrolyte contained in the solid electrolyte layer is in the above-described range with respect to the particle diameter of the solid electrolyte contained in the positive electrode layer and the particle diameter of the solid electrolyte contained in the negative electrode layer, it is possible to more reliably prevent foreign matter from moving to the solid electrolyte layer when foreign matter is present in the positive electrode layer or the negative electrode layer.

The average particle diameter D50 of the solid electrolyte contained in the positive electrode layer and the negative electrode layer is not particularly limited, and can be greater than or equal to 0.7 μm and less than or equal to 2.0 μm, greater than or equal to 0.8 μm and less than or equal to 1.8 μm, and greater than or equal to 0.9 μm and less than or equal to 1.5 μm.

The average particle diameter D50 of the solid electrolyte contained in the solid electrolyte layer is not limited as long as it is smaller than the average particle diameter D50 of the solid electrolyte contained in the positive electrode layer and the negative electrode layer, and can be, for example, greater than or equal to 0.35 μm and less than or equal to 1.0 μm, greater than or equal to 0.4 μm and less than or equal to 0.9 μm, and greater than or equal to 0.45 μm and less than or equal to 0.75 μm. In particular, the average particle diameter D50 of the solid electrolyte contained in the solid electrolyte layer is not limited as long as it is smaller than the average particle diameter D50 of the solid electrolyte contained in the positive electrode layer and the negative electrode layer, and can be, for example, greater than or equal to 0.14 μm and less than or equal to 0.4 μm, and greater than or equal to 0.16 μm and less than or equal to 0.36 μm, and greater than or equal to 0.19 μm and less than or equal to 0.3 μm.

A solid electrolyte of a predetermined particle diameter which is used for the solid electrolyte layer, and a solid electrolyte which is used for the positive electrode layer and the negative electrode layer and which has a different particle diameter from the solid electrolyte of a predetermined particle diameter which is used for the solid electrolyte layer, can be produced by appropriately applying known grinding methods. Examples of the grinding method include a media grinding method, a jet grinding method, and a cavitation grinding method. Furthermore, a grinder is not particularly limited, and examples thereof include a bead mill and a planetary ball mill. The grinding conditions can be appropriately set so as to obtain a solid electrolyte having a desired average particle diameter.

Generally, a solid electrolyte can be used without limitation as the solid electrolyte used for a solid-state battery. As such solid electrolytes, crystalline nitrides, oxides, sulfides and oxoacid salts, and materials having an amorphous glass structure can be used. Specifically, sulfide solid electrolytes which can be used as solid electrolytes include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, Li₃PS₄, LiCl—LiBr—Li₃PS₄, LiCl—LiBr—Li₂S—P₂S₅, and LiCl—LiBr—Li₂S—SiS₂. Further, examples of the oxide-based solid electrolytes include Li_{0.34}La_{0.56}TiO₃, Li_{3/8}Sr_{7/16}Ta_{3/4}M_{1/4}O₃ (M=Zr or Hf), Li₇La₃Zr₂O₁₂, Li_{1.3}Al_{0.7}Ti_{1.3}(PO₄)₃, Li_{1.5}Al_{0.5}Ge_{1.5}(PO₄)₃, Li_{3.5}Ge_{0.5}V_{0.5}O, Li_{2.88}PO_{3.73}N_{0.14}, and Li_{2.9}Si_{0.45}PO_{1.6}N_{1.3}. Furthermore, as the solid electrolyte, a complex hydride-based lithium ion conductor or a halide-based lithium ion conductor may be used.

### Active Material

In the present disclosure, the positive electrode active material is not particularly limited, and conventionally known materials can be appropriately used. Examples of the positive electrode active material include LiCoO₂, LiNiO₂, LiMnO₂, LiMn₂O₄, Li(NiCoMn)O₂, Li(NiCoAl)O₂, and LiFePO₄. It should be noted that “(NiCoMn)” in “Li(NiCoMn)O₂” indicates that the sum of the composition ratios in parentheses is 1. As long as the sum is 1, the amounts of the individual components are optional. Further, as the positive electrode active material, for example, the Li(NiCoMn)O₂ may contain Li(Ni_{1/3}Co_{1/3}Mn_{1/3})O₂, Li(Ni_{0.5}Co_{0.2}Mn_{0.3})O₂, and Li(Ni_{0.8}Co_{0.1}Mn_{0.1})O₂. It should be noted that the positive electrode active material particles may be Hi-Nickel (a positive electrode active material having a high Ni ratio) or a ternary positive electrode active material.

In the present disclosure, the negative electrode active material is not particularly limited, and conventionally known materials can be appropriately used. Examples of the negative electrode active material include graphite, Si, SiOx (0<x<2), and Li₄Ti₅O₁₂. Furthermore, in the present disclosure, a coating layer (sometimes referred to as a protective layer) may be formed on at least a part, preferably the entire surface of the surface of the positive electrode active material and/or the negative electrode active material. The coating layer is not particularly limited, and for example, a Li-ion conductive oxide can be used. The coating layer can be formed by coating the surface of the active material with a Li-ion conductive oxide.

### Other Components

In the present disclosure, the solid electrolyte layer, the positive electrode layer, and the negative electrode layer which configure the solid-state battery can contain other components in addition to the solid electrolytes and the active materials which are described above. Examples of the other components include a conductive auxiliary agent. The conductive auxiliary agent can be appropriately selected from conductive auxiliary agents that can be applied to solid-state batteries. Examples of the conductive auxiliary agent include carbon black, vapor-grown carbon fibers (VGCF), carbon nanotubes (CNTs), and graphene flakes. For example, carbon materials such as acetylene black and Ketjen black, and metal materials such as nickel, aluminum, and stainless steel may be used as the conductive auxiliary agent.

Furthermore, in the present disclosure, examples of the other components include a binder. As the binder, any conventionally known material that is used for an electrode for a solid-state battery can be used. Examples of the binder include butadiene rubber (BR), butylene rubber (IIR), acrylate butadiene rubber (ABR), styrene-butadiene rubber (SBR), polyvinylidene fluoride (PVdF), and polyvinylidene fluoride-hexafluoropropylene copolymer (PVdF-HFP).

### Production of Solid-State Battery

In the present disclosure, a solid-state battery including a solid electrolyte layer, a positive electrode layer, and a negative electrode layer can be manufactured by conventionally known methods using, as materials, the solid electrolytes, the active materials, and the other components which are described above. The solid electrolyte layer, the positive electrode layer, and the negative electrode layer may be produced, for example, by a dry film forming method without using a solvent, or may be produced by a wet film forming method using a solvent. As the dry film forming method, for example, the solid electrolyte layer, the positive electrode layer, and the negative electrode layer may be produced by mixing and pressing the materials configuring each layer. Furthermore, as the dry film forming method, an electrode may be manufactured by dispersing a material configuring each layer in a dispersant to form a slurry, applying the slurry to a predetermined substrate, and drying the slurry.

As an example, for a method of manufacturing the positive electrode layer using a slurry, first, a positive electrode active material, a solid electrolyte, a conductive auxiliary agent, and the like are stirred in a solvent (also referred to as a dispersion medium) and mixed to prepare a slurry. Examples of the solvent include, but are not limited to, 1,2,3,4-tetrahydronaphthalene, butyl acetate, heptyl butyrate, mesitylene, tetralin, heptane, and N-methyl-2-pyrrolidone (NMP). The obtained slurry is then applied to the substrate by a conventionally known method. The substrate to which the slurry is applied is not particularly limited, and may be a metal foil, a current collector, or a solid electrolyte layer. The coating method can be carried out by a known method. Examples thereof include conventional methods such as a doctor blade method, a die coating method, a gravure coating method, a spray coating method, an electrostatic coating method, and a bar coating method.

Next, the slurry applied to the substrate is dried. At this time, the slurry may be heated to a range of from 50° C. to less than or equal to 200° C., or the atmosphere may be set to an inert atmosphere or a reduced-pressure atmosphere. It should be noted that the negative electrode layer can be prepared in the same manner as the positive electrode layer except that a negative electrode active material is used instead of the positive electrode active material. Furthermore, the solid electrolyte layer can be produced in the same manner as the positive electrode layer except that no active material is used and the solid electrolyte used for the above-described solid electrolyte layer is used.

The structure of a solid-state battery has a layered structure of positive electrode layer/solid electrolyte layer/negative electrode layer. Solid-state batteries include so-called all-solid-state batteries in which a solid electrolyte is used as an electrolyte, and the solid electrolyte may contain less than 10% by mass of an electrolytic solution based on the total amount of the electrolyte. It should be noted that the solid electrolyte may be a composite solid electrolyte containing an inorganic solid electrolyte and a polymer electrolyte.

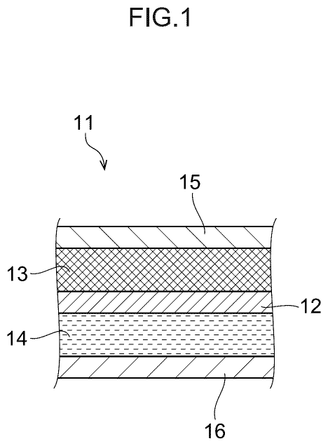

As an embodiment of the present disclosure, FIG. 1 illustrates a schematic structural diagram of the main parts of an all-solid-state battery. As illustrated in FIG. 1, an all-solid-state battery 11 according to the present embodiment includes a solid electrolyte layer 12, a positive electrode layer 13 and a negative electrode layer 14 arranged via the solid electrolyte layer 12, a positive electrode current collector foil 15, which is an example of a positive electrode current collector that is arranged on a surface of the positive electrode layer 13 which is opposite to the surface in contact with the solid electrolyte layer 12, and a negative electrode current collector foil 16, which is an example of a negative electrode current collector that is arranged on a surface of the negative electrode layer 14 which is opposite to the surface in contact with the solid electrolyte layer 12. It should be noted that, although not illustrated in the drawing, the all-solid-state battery 11, which is illustrated as the present embodiment, has a configuration such as a positive electrode tab lead electrically connected to the positive electrode current collector foil 15, a negative electrode tab lead electrically connected to the negative electrode current collector foil 16, and other packing materials.

In the embodiment illustrated in FIG. 1, an all-solid-state battery having a single cell structure in which the solid electrolyte layer 12, the positive electrode layer 13, and the negative electrode layer 14 are used as one unit is illustrated. However, the solid-state battery according to the present disclosure is not limited to the embodiment illustrated in FIG. 1, and may be, for example, an all-solid-state battery having a structure in which plural units are stacked in a thickness direction with the solid electrolyte layer 12, the positive electrode layer 13, and the negative electrode layer 14 as one unit. The all-solid-state battery may be a monopolar layered battery (a parallel connection type layered battery), or may be a bipolar layered battery (a series connection type layered battery). Examples of the shape of the all-solid-state battery include a coin type, a laminate type, a cylindrical type, and a rectangular type, and the all-solid-state battery according to the present disclosure is not limited to a specific shape.

The positive electrode current collector foil 15 and the negative electrode current collector foil 16 have any configuration in the solid-state battery according to the present disclosure. The material of the positive electrode current collector foil 15 and the negative electrode current collector foil 16 is not particularly limited, and can be appropriately selected from known materials. Examples of the material of the positive electrode current collector foil 15 and the negative electrode current collector foil 16 include Cu, Ni, Cr, Au, Pt, Ag, Al, Fe, Ti, Zn, Co, and stainless-steel. The thickness of each of the positive electrode current collector foil 15 and the negative electrode current collector foil 16 is not particularly limited, and can be, for example, in a range of greater than or equal to 0.1 μm and less than or equal to 1 mm.

The all-solid-state battery described in the above-described embodiment can be manufactured by disposing the solid electrolyte layer 12 between the positive electrode layer 13 and the negative electrode layer 14 using the positive electrode layer 13 and the negative electrode layer 14 prepared as described above and the separately prepared solid electrolyte layer 12, and layering the positive electrode layer 13, the solid electrolyte layer 12, and the negative electrode layer 14 so as to be interposed between the positive electrode current collector foil 15 and the negative electrode current collector foil 16. An example thereof includes a method in which the positive electrode layer 13, the solid electrolyte layer 12, and the negative electrode layer 14 are layered in this order, and then pressed by a predetermined method, and thereafter, the positive electrode current collector foil 15 and the negative electrode current collector foil 16 are arranged. Furthermore, the positive electrode layer 13, the solid electrolyte layer 12, and the negative electrode layer 14 can be pressed by a predetermined method in a state of being interposed between the positive electrode current collector foil 15 and the negative electrode current collector foil 16. The pressing method is not particularly limited, and examples thereof include roll pressing and flat plate pressing. The line pressure applied during roll pressing is, for example, greater than or equal to 1 t/cm² or more, and may be less than or equal to 10 t/cm². The surface pressure applied during flat plate pressing may be, for example, greater than or equal to 800 MPa and less than or equal to 3000 MPa.

The solid electrolyte layer 12 is a layer that is arranged between the positive electrode layer 13 and the negative electrode layer 14 and contains at least a solid electrolyte. The solid electrolyte layer 12 contains, as described above, a solid electrolyte having a particle diameter that is smaller than the solid electrolyte contained in the positive electrode layer 13 and smaller than the solid electrolyte contained in the negative electrode layer 14. As a result, even if foreign matter is present in the positive electrode layer 13 or the negative electrode layer 14, the foreign matter can be prevented from moving to the solid electrolyte layer 12.

For example, in a case in which the positive electrode layer 13 is positioned above the solid electrolyte layer 12 (above with respect to a gravity direction), if foreign matter is present in the positive electrode layer 13, the foreign matter moves toward the solid electrolyte layer 12 due to vibration or the like. However, in the solid-state battery according to the present disclosure, since the particle diameter of the solid electrolyte contained in the solid electrolyte layer 12 is smaller than the particle diameter of the solid electrolyte contained in the positive electrode layer 13, even if foreign matter can move in the direction of the solid electrolyte layer 12 in the positive electrode layer 13, a greater force is required to advance into the solid electrolyte layer 12. Therefore, in the solid-state battery according to the present disclosure, foreign matter present in the positive electrode layer 13 can be suppressed from advancing into the solid electrolyte layer 12. It should be noted that even in a case in which the negative electrode layer 14 is positioned above the solid electrolyte layer 12 (above with respect to a gravity direction), it is possible to suppress foreign matter present in the negative electrode layer 14 from advancing into the solid electrolyte layer 12 in the same manner.

It should be noted that foreign matter present in the positive electrode layer 13 or the negative electrode layer 14 means dust, a piece of metal, and dendrites of metallic lithium generated on the side of the negative electrode layer 14, which have been mixed in the manufacturing process of the all-solid-state battery. Therefore, foreign matter may be present in the positive electrode layer 13 and/or the negative electrode layer 14, and is not an element configuring the solid-state battery according to the present disclosure.

As foreign matter that can be present in the positive electrode layer 13 and/or the negative electrode layer 14, a conductive material such as a piece of metal is conceivable. Even if a conductive material is present as foreign matter in the positive electrode layer 13 and/or the negative electrode layer 14, in the solid-state battery according to the present disclosure, movement of the conductive material into the solid electrolyte layer 12 can be suppressed, whereby a short circuit between the positive electrode layer 13 and the negative electrode layer 14 can be prevented. Furthermore, even if foreign matter that may be present in the positive electrode layer 13 and/or the negative electrode layer 14 is a non-conductive material, in the solid-state battery according to the present disclosure, since movement of the non-conductive material into the solid electrolyte layer 12 can be suppressed, a partial defect in the solid electrolyte layer 12 can be prevented. As a result, the solid-state battery according to the present disclosure can avoid problems such as short circuiting between the positive electrode layer 13 and the negative electrode layer 14 and voltage drop due to defects in the solid electrolyte layer 12, and can exhibit excellent battery performance.

For the solid-state battery of the present disclosure, as described above, whether a problem such as a voltage drop due to a short circuit or the like will occur or whether the occurrence of the problem has been avoided can be determined by the method described in the Examples, which are described in detail below. As a general example, a method whereby a state in which a short circuit due to foreign matter is likely to occur by a method such as a vibration load test is made, and a voltage change of a solid-state battery in this state is measured, can be exemplified.

### EXAMPLES

Hereinafter, although a solid-state battery according to the present disclosure will be described by way of Examples, the technical scope of the present disclosure is not limited to the following Examples.

### Examples 1 and 2, and Comparative Example 1

In the present Examples, plural types of solid electrolytes having different particle diameters were used as the solid electrolyte used for the solid electrolyte layer. Furthermore, in the all-solid-state battery prepared in the present Examples, a piece of metal (foreign matter) of 200 μm×200 μm×1 μm was sealed in the positive electrode layer (positioned above the solid electrolyte layer with respect to a gravity direction). Foreign matter short-circuit tests were conducted using these solid electrolytes.

More specifically, the all-solid-state batteries were prepared as follows.

First, a positive electrode layer (thickness: 70 μm) was prepared using lithium cobalt oxide (particle diameter (D50): 5 μm) as the positive electrode active material, and a Li₂S—P₂S₅ compound (particle diameter (D50): 1 μm) as the solid electrolyte. Further, a negative electrode layer (thickness: 50 μm) was prepared using lithium titanate (particle diameter (D50): 1.2 μm) as the negative electrode active material and a Li₂S—P₂S₅ compound (particle diameter (D50): 1 μm) as the solid electrolyte. Furthermore, as the solid electrolyte layer, three types of solid electrolytes (Li₂S—P₂S₅ compounds) having average particle diameters D50 of 1 μm, 0.5 μm, and 0.2 μm were prepared, and a solid electrolyte layer having a thickness of 15 μm was prepared using the respective solid electrolytes. Moreover, a positive electrode foil configured by aluminum (Al) was affixed to an outer side of the positive electrode layer, and a negative electrode foil configured by copper (Cu) was affixed to an outer side of the negative electrode layer.

An all-solid-state battery, in which a solid electrolyte having an average particle diameter D50 of 1 μm was used as a solid electrolyte layer, was used as Comparative Example 1. Furthermore, an all-solid-state battery, in which a solid electrolyte having an average particle diameter D50 of 0.5 μm was used as the solid electrolyte layer, was used as Example 1. Furthermore, an all-solid-state battery, in which a solid electrolyte having an average particle diameter D50 of 0.2 μm was used as the solid electrolyte layer, was used as Example 2.

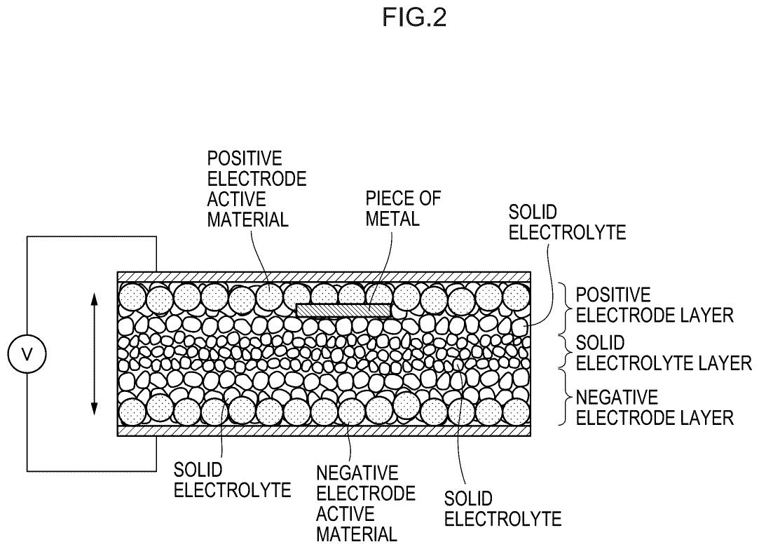

Foreign matter short-circuit tests were conducted as follows using the all-solid-state batteries of Comparative Example 1, Example 1, and Example 2, which were prepared as described above. First, the voltage was measured as shown in FIG. 2 while applying a vibration load of 4 G in the direction in which the positive electrode layer, the solid electrolyte layer, and the negative electrode layer of the produced all-solid-state battery were layered. In the tests, a vibration load of 4 G was loaded under the conditions of a frequency of 25 Hz and a period of time of 600 seconds, and voltage changes during the test period were detected. It should be noted that when a piece of metal advances to the solid electrolyte layer and a short circuit occurs, a voltage drop accompanied by an initial spike (an instantaneous drop in voltage) occurs. Therefore, it can be determined that a short circuit has occurred when an instantaneous drop in voltage occurs.

Table 1 shows the results of the foreign matter short-circuit tests using all-solid-state batteries of Comparative Example 1, Example 1, and Example 2. It should be noted that the foreign matter short-circuit test was performed 10 times for the all-solid-state batteries of Comparative Example 1, Example 1, and Example 2 after changing the position of the piece of metal. Specifically, the foreign matter short-circuit test was performed twice for each of the all-solid-state batteries of Comparative Example 1, Example 1, and Example 2 at a total of 5 locations in which the position of the piece of metal piece was near the center on the upper surface of the all-solid-state battery or near one of the four corners on the upper surface of the all-solid-state battery.

TABLE 1

| | Comparative | | |
|---|---|---|---|
| | Example 1 | Example 1 | Example 2 |
| Particle Diameter of Solid | 1 μm | 0.5 μm | 0.2 μm |
| Electrolyte of Solid | | | |
| Electrolyte Layer | | | |
| Particle Diameter of Solid | 1 μm | 1 μm | 1 μm |
| Electrolyte of Positive | | | |
| Electrode Layer and Negative | | | |
| Electrode Layer | | | |
| Voltage Drop | Occurred | Almost | None |
| | | None | |

As shown in Table 1, it has been found that by making the particle diameter of the solid electrolyte of the solid electrolyte layer smaller than the particle diameter of the solid electrolyte used for the positive electrode layer and/or the negative electrode layer, short circuiting caused by foreign matter present in the positive electrode layer can be prevented. In Example 1, in which a relative value of the particle diameter of the solid electrolyte of the solid electrolyte layer was 0.5 when a value of the particle diameter of the solid electrolyte used for the positive electrode layer and/or the negative electrode layer was set to 1, although a partial voltage drop was observed, the effect of preventing internal short circuiting of the battery was observed. In particular, it has been found that when a relative value of the particle diameter of the solid electrolyte of the solid electrolyte layer is less than or equal to 0.2 when a value of the particle diameter of the solid electrolyte used for the positive electrode layer and/or the negative electrode layer was set to 1, it is possible to more reliably prevent a short circuit caused by foreign matter present in the positive electrode layer.

What is claimed is:

1. A solid-state battery, comprising:
a positive electrode layer that includes a positive electrode active material and a solid electrolyte;
a negative electrode layer that includes a negative electrode active material and a solid electrolyte; and
a solid electrolyte layer that is arranged between the positive electrode layer and the negative electrode layer,
wherein a particle diameter of a solid electrolyte that is included in the solid electrolyte layer is smaller than a particle diameter of the solid electrolyte that is included in the positive electrode layer and smaller than a particle diameter of the solid electrolyte that is included in the negative electrode layer.

2. The solid-state battery according to claim 1, wherein a relative value of the particle diameter of the solid electrolyte that is included in the solid electrolyte layer is less than or equal to 0.5 in a case in which a value of a smaller particle diameter among the solid electrolyte that is included in the positive electrode layer and the solid electrolyte that is included in the negative electrode layer is set to 1.

3. The solid-state battery according to claim 1, wherein a relative value of the particle diameter of the solid electrolyte that is included in the solid electrolyte layer is less than or equal to 0.2 in a case in which a value of a smaller particle diameter among the solid electrolyte that is included in the positive electrode layer and the solid electrolyte that is included in the negative electrode layer is set to 1.
